(19) United States
(12) Patent Application Publication
(10) Pub. No.: US 2020/0376339 A1
(43) Pub. Date: Dec. 3, 2020

(54) IMMERSIVE VIRTUAL REALITY EXERCISE SYSTEM AND METHOD

(71) Applicant: Defond Electrical Industries Limited, Chai Wan (HK)

(72) Inventor: Wai Cheong Wilson CHU, Chai Wan (HK)

(21) Appl. No.: 16/423,582

(22) Filed: May 28, 2019

(51) Int. Cl. A63B 24/00; A63B 21/00; G06T 19/00

(52) U.S. Cl. CPC A63B 24/0087; A63B 21/00058; A63B 2024/0093; A63B 2024/009; G06T 19/006

(57) ABSTRACT

An exercise system includes an exercise machine with a user engagement structure configured to be engaged by a user to perform a physical exercise. Actuators are configured to adjust operation of the user engagement structure to dynamically vary the physical exercise performed by the user. The system also includes a virtual reality apparatus with an immersive environment module that provides an immersive exercise environment to the user. The system also includes a computing device to control the actuators and the immersive environment module so that the physical exercise and the immersive exercise environment are dynamically varied to mimic the virtual reality exercise environment provided by the virtual reality apparatus.

### FIELD OF THE INVENTION

The present invention relates to an immersive virtual reality exercise system and method.

### BACKGROUND OF THE INVENTION

Static exercise machines, and gyms in which they are used, are often provided with conventional video displays to make physical exercise on the machines less tedious and more engaging. In addition, users of exercise machines often use conventional audio devices, such as music players and smartphones, to reduce the tedium and boredom of repetitive physical exercise on exercise machines.

The use of conventional video displays and audio devices by users of exercise machines suffers from several drawbacks. Such devices typically only provide users with limited distraction and entertainment during tedious and repetitive physical exercise on exercise machines. Furthermore, conventional video displays and audio devices are incapable of ‘immersing’ users of exercise machines in engaging exercise environments that simulate or mimic real-world physical exercise.

A need therefore exists for immersive virtual reality exercise systems and methods for increasing user engagement and immersion during physical exercise on exercise machines.

### SUMMARY OF THE INVENTION

According to the present invention, there is provided an exercise system, comprising:

an exercise machine comprising a user engagement structure configured to be engaged by a user to perform a physical exercise;

actuators configured to adjust operation of the user engagement structure to dynamically vary the physical exercise performed by the user;

a virtual reality apparatus configured to provide a virtual reality exercise environment to the user;

an immersive environment module configured to provide an immersive exercise environment to the user; and

a computing device configured to control the actuators and the immersive environment module so that the physical exercise and the immersive exercise environment are dynamically varied to at least partially simulate or mimic the virtual reality exercise environment provided by the virtual reality apparatus.

The computing device may comprise a user interface configured to enable user selection of one or both of a physical exercise routine and prerecorded video content, wherein the virtual reality exercise environment is based at least in part on one or both of the selected physical exercise routine and the selected prerecorded video content.

The prerecorded video content may include prerecorded video content of a real-world environment such as a track, trail, roadway or circuit for running, cycling, or rowing being traversed. Alternately and/or additionally, the prerecorded video content may include video content which simulates a real-world environment such as a track, trail, roadway or circuit for running, cycling, or rowing being traversed.

The exercise system may further comprise image recognition software configured to recognise the physical exercise routine from the prerecorded video content.

The physical exercise routine may be based at least in part on performance data and environmental data sensed during the user performing the prerecorded physical exercise.

One or both of the virtual reality exercise environment and the immersive exercise environment may be based at least in part on one or more of the physical exercise routine, the performance data and the environmental data.

The actuators may be further configured to dynamically adjust resistance provided by the user engagement structure.

The actuators may be further configured to dynamically adjust orientation of one or both of the user engagement structure and the exercise machine.

The exercise machine may be selected from an exercise bike, a treadmill, a rowing machine, a stair climber, and an elliptical trainer.

The virtual reality apparatus may comprise a virtual reality headset or a plurality of virtual reality displays.

The immersive environment module may be further configured to provide one or both of sensory stimuli and haptic feedback to the user that at least partially simulates or mimics the virtual reality exercise environment provided by the virtual reality apparatus.

The exercise system may further comprise performance sensors configured to sense performance data of the user during performance of the physical exercise.

The exercise system may further comprise performance analysis software configured to analyse the performance data of the user during performance of the physical exercise.

The computing device may further comprise a network interface configured to communicate with one or more other exercise systems or one or more other computing devices via one or more networks.

The present invention also provides method of performing a physical exercise using a computer-controlled exercise machine, the method comprising:

providing a user of the computer-controlled exercise machine with a virtual reality exercise environment during performance of the physical exercise;

providing the user with an immersive exercise environment during performance of the physical exercise;

controlling the computer-controlled exercise machine and dynamically varying the immersive exercise environment during performance of the physical exercise to at least partially simulate or mimic the virtual reality exercise environment.

### BRIEF DESCRIPTION OF DRAWINGS

Embodiments of the invention will now be described by way of example only with reference to the accompanying drawings, in which:

FIG. 1 is a schematic block diagram of an immersive virtual reality exercise system according to an embodiment of the present invention; and

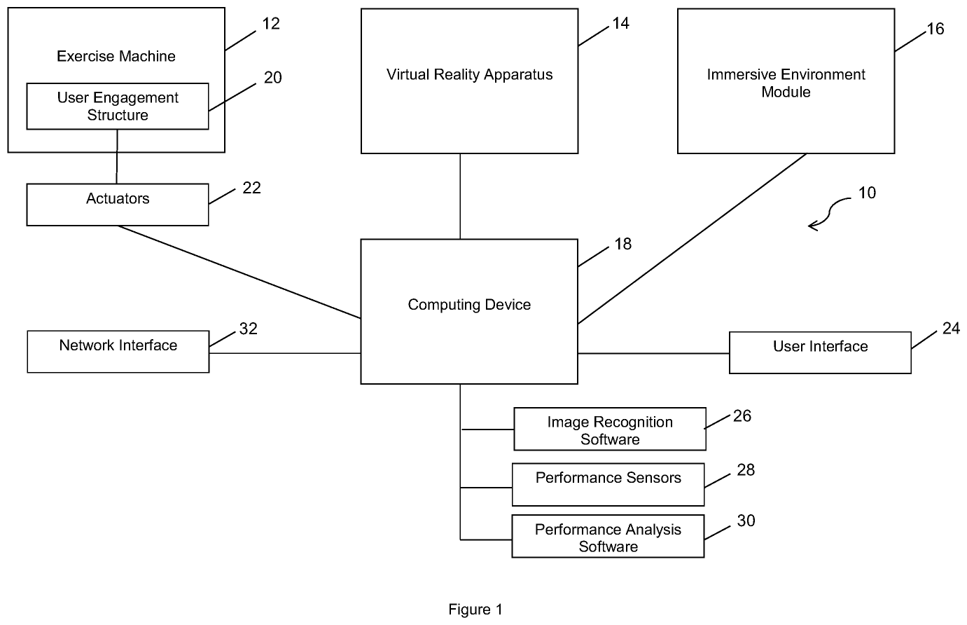

FIG. 2 is a flow chart of a method of performing a physical exercise using a computer-controlled exercise machine controlled by the immersive virtual reality exercise system of FIG. 1.

### DESCRIPTION OF EMBODIMENTS

Referring to the drawing, an immersive virtual reality exercise system 10 according to an embodiment of the present invention may generally comprise an exercise machine 12, a virtual reality apparatus 14, an immersive environment module 16, and a computing device 18. The exercise machine 12 may comprise a user engagement structure 20 configured to be engaged by a user to perform a physical exercise, for example, cycling, running, rowing, stair climbing etc. The exercise machine 12 may comprise an exercise bike, a treadmill, a rowing machine, a stair climber, an elliptical trainer, etc. The user engagement structure 20 may be based on the type of exercise machine 12 used. For example, when the exercise machine 12 is an exercise bike, the user engagement structure 20 may comprise bike pedals.

The exercise system 10 may further comprise actuators 22, such as rotary actuators, linear actuators rotating eccentric mass actuators, and/or rocking mass actuators, configured to adjust operation of the user engagement structure 20 to dynamically vary the physical exercise performed by the user. The actuators 22 may be further configured to dynamically adjust resistance provided by the user engagement structure 20. Further or alternatively, the actuators 22 may be further configured to dynamically adjust orientation of one or both of the user engagement structure 22 and the exercise machine 12. In use, the actuators 22 may therefore dynamically adjust operation, configuration and/or orientation (and hence the forces applied to the user) of the user engagement structure 20 and/or the exercise machine 12, for example, by moving left, right, front, back, tilting backwards/forwards, changing vertical/horizontal displacement, imparting vibrational, rocking or rolling motion, etc.

The virtual reality apparatus 14 may be configured to provide a virtual reality exercise environment to the user during performance of the physical exercise on the exercise machine 12. The virtual reality apparatus 14 may, for example, comprise a virtual reality headset (or googles), or a plurality of virtual reality displays that at least partially surround the exercise machine 12. The virtual reality exercise environment may comprise a three-dimensional (3D) virtual reality exercise environment and/or an augmented virtual reality exercise environment.

The immersive environment module 16 may be configured to provide an immersive exercise environment to the user during performance of the physical exercise on the exercise machine 12. The immersive environment module 16 may be further configured to provide one or both of sensory stimuli and haptic feedback to the user that at least partially simulates or mimics the virtual reality exercise environment provided by the virtual reality apparatus 14. The sensory stimuli may, for example, comprise light, sound, noise, temperature, smell, etc. The haptic feedback may comprise, for example, vibration, rocking, rolling, jumping, etc. The immersive environment module 16 may, for example, comprise one or more of lights, cooling fans, heating fans, sprayers, humidifiers, speakers, noise generators, etc.

In use, the immersive environment module 16 may provide an immersive exercise environment to the user of the exercise machine 12. For example, the immersive environment module 16 may be controlled by the computing device 18 to blow air or water onto the user, and to heat or cool the user to simulate or mimic dynamically changing environmental and weather conditions. In addition, the immersive environment module 16 may be controlled by the computing device 18 to dynamically change lighting conditions to simulate time of day, shade, etc. Furthermore, the immersive environment module 16 may generate noises and sounds to simulate, mimic or augment the sounds (eg, sound of trees blown by wind, birds and animals, crowds cheering, traffic, etc) represented by what is shown in the video stream in real-time. For example, if the videos stream is showing a bike trail by the beach, the user may hear the simulated sound of waves, and feel the wind from the ocean and droplets of water from the ocean spray.

The computing device 18 may be configured to control the actuators 22 and the immersive environment module 16 so that, in use, the physical exercise and the immersive exercise environment are dynamically varied so as to at least partially simulate or mimic the virtual reality exercise environment provided by the virtual reality apparatus 14. For example, the virtual reality exercise environment may provide prerecorded video and audio streams of actual real-world bike rides (e.g., different stages of the Tour de France) or running trails to the user when using the exercise machine 12.

In use, the actuators 22 may be dynamically controlled by the computing device 18 to dynamically effect movement of the user engagement structure 20 and/or the exercise machine 12 in a manner which closely simulates, mimics or reflects the environment and terrain represented in video content (or video streams) playing on the virtual reality apparatus 14 system in real-time. For example, the actuators 22 may tilt the bike or treadmill platform upward if the trail is shown heading up a mountain, or vibrational motion may be created to simulate travelling over a rough and rocky trail shown in the video stream.

The computing device 18 may further configured to control the actuators 22 to adjust to vary operation of the user engagement structure 20 and/or the exercise machine 12 so that the resistance applied to the user depends upon whether the video stream shows the trail going uphill, downhill, the nature of the terrain, etc. Accordingly, for an exercise bike embodiment, the load felt on the pedals may be relatively heavy when the video represents going uphill, and relatively light when going downhill.

The computing device 18 may, for example, comprise one or more programmable servers, computer controllers, desktop computers, laptop computers, tablet computers, smartphones, and combinations thereof. The computing device 18 may further comprise a user interface 24, such as a control panel, console or smartphone display, configured to enable user selection of one or both of a physical exercise routine and prerecorded video content. In this embodiment, the prerecorded video content comprises a plurality of real-world environments such as tracks, trails, roadways or circuits for running, cycling, or rowing being traversed. By way of example, prerecorded video content could be of various stages of a famous cycling course such as the Tour de France being traversed. Such real-world environments provide a more realistic and immersive effect for the user and enhances the overall user experience. Additionally and/or alternately, the prerecorded video content may include a simulation (e.g. computer generated imagery) of a real-environment being traversed.

The user interface 24 may be implemented as web and/or mobile software applications comprising one or more computer program modules executable by the computing device 18. The virtual reality exercise environment may be based at least in part on one or both of the selected physical exercise routine and the selected prerecorded video content. The prerecorded video content may comprise prerecorded video content of the user performing the physical exercise. The prerecorded video content may be selected from a curated library of video content that may be streamed from and/or stored on one or more servers and associated databases accessible by the computing device 18.

The computing device 18 may be further configured to provide an online platform for immersive virtual reality software where users can set up an account, and upload and share their own recorded videos with other users so that shared video streams are usable by different exercise bikes/treadmills. Different videos streams may also be searchable by filters such as level of difficulty, popularity, geography, and environment (eg, forest, dessert, urban etc). The online platform for immersive virtual reality software may be implemented as web and/or mobile software applications comprising one or more computer program modules executable by the computing device 18.

The exercise system 10 may further comprise image recognition software 26 executable by the computing device 18 and configured to recognise the physical exercise routine from the prerecorded video content. The image recognition software 24 may be implemented as web and/or mobile software applications comprising one or more computer program modules executable by the computing device 18. The physical exercise routine may be based at least in part on performance data and environmental data sensed during the user performing the prerecorded physical exercise. One or both of the virtual reality exercise environment and the immersive exercise environment may be based at least in part on one or more of the physical exercise routine, the performance data and the environmental data.

There are various ways in which the computing device 18 of the exercise system 10 may be configured to control the actuators 22 and the immersive environment module 16 to closely simulate, mimic or reflect the virtual reality exercise environment provided by the virtual reality apparatus 14. For example, the computing device 18 may be manually programmed via the user interface 24 to operate the actuators 22 and the immersive environment module 16 so as to correspond with the environment, terrain, weather conditions, etc., being displayed on the video stream.

Alternatively, a user may record performance of a physical exercise, for example bike riding or trail running, using a video camera and a mobile app running on a smartphone paired with the video camera. The app may use in-built sensors of the smartphone to sense and record performance data and environmental data while the user is videoing and performing the physical exercise. The performance data and environmental data may, for example comprise the orientation of the bike/runner, the ambient light, ambient noise, speed temperature conditions, weather conditions, terrain (bumpy, smooth, etc.) etc. The app may convert the recorded sensor data into computer control instructions for controlling the actuators 22 and/or the exercise machine 12, and the immersive environment module 16, while the virtual reality exercise environment based on the video recording is played back to the user via the virtual reality apparatus 14.

Further or alternatively, the image recognition software 26 may be configured to automatically identify, extract or recognise the orientation of the bike/runner from the recorded video stream, as well as other environmental features, and to generate appropriate computer instructions for controlling the actuators 22 and the immersive environment module 16 when the video stream is being played back to the user via the virtual reality apparatus 14.

The exercise system 10 may further comprise performance sensors 28 configured to sense performance data of the user during performance of the physical exercise. The performance data may, for example, comprise speed, completion time, heart rate, calories burned and other biometric indicators, etc. The exercise system 10 may further comprise performance analysis software 30 configured to analyse the performance data of the user during performance of the physical exercise. The performance analysis software 30 may be implemented as web and/or mobile software applications comprising one or more computer program modules executable by the computing device 18. The sensed and analysed performance data may be stored and shared to a mobile app via the online platform provided by the exercise system 10.

The computing device 10 may further comprise a network interface 32 configured to communicate with one or more other exercise systems 10 or one or more other computing devices 18 via one or more networks. Multiple exercise bikes/treadmills may be networked together via a LAN, WAN, internet, etc., so that multiple users may experience the same ride or trail in either competitive formats (i.e., racing) or non-competitive formats (i.e., training).

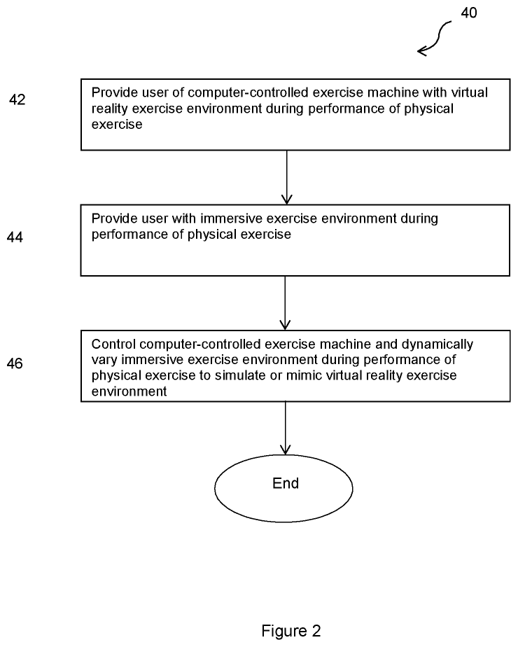

Referring to FIG. 2, a method 40 of performing a physical exercise performed by the exercise system 10 starts at step 42 by providing a user of a computer-controlled exercise machine 12 with a virtual reality exercise environment during performance of the physical exercise. Then, at step 44, the user is provided with an immersive exercise environment during performance of the physical exercise. Next, at step 46, during performance of the physical exercise, the computer-controlled exercise machine 12 is controlled, and the immersive exercise environment is dynamically varied, so as to at least partially simulate or mimic the virtual reality exercise environment.

Embodiments of the present invention provide immersive virtual reality exercise systems and methods that are generally and specifically useful for increasing user engagement and immersion during physical exercise on exercise machines.

For the purpose of this specification, the word “comprising” means “including but not limited to,” and the word “comprises” has a corresponding meaning.

The above embodiments have been described by way of example only and modifications are possible within the scope of the claims that follow.

What is claimed:

1. An exercise system, comprising:
an exercise machine comprising a user engagement structure configured to be engaged by a user to perform a physical exercise;
actuators configured to adjust operation of the user engagement structure to dynamically vary the physical exercise performed by the user;
a virtual reality apparatus configured to provide a virtual reality exercise environment to the user;
an immersive environment module configured to provide an immersive exercise environment to the user; and
a computing device configured to control the actuators and the immersive environment module so that the physical exercise and the immersive exercise environment are dynamically varied to at least partially simulate or mimic the virtual reality exercise environment provided by the virtual reality apparatus.

2. The exercise system of claim 1, wherein the computing device comprises a user interface configured to enable user selection of one or both of a physical exercise routine and prerecorded video content, and wherein the virtual reality exercise environment is based at least in part on one or both of the selected physical exercise routine and the selected prerecorded video content.

3. The exercise system of claim 2, wherein prerecorded video content includes at least one of a prerecorded video content of a real-world environment such as a track, trail, roadway or circuit for running, cycling, or rowing being traversed, and, a prerecorded video content which simulates a real-world environment such as a track, trail, roadway or circuit for running, cycling, or rowing being traversed.

4. The exercise system of claim 3, further comprises image recognition software configured to recognise the physical exercise routine from the prerecorded video content.

5. The exercise system of claim 4, wherein the physical exercise routine is based at least in part on performance data and environmental data sensed during the user performing the prerecorded physical exercise.

6. The exercise system of claim 5, wherein one or both of the virtual reality exercise environment and the immersive exercise environment are based at least in part on one or more of the physical exercise routine, the performance data and the environmental data.

7. The exercise system of claim 1, wherein the actuators are further configured to dynamically adjust resistance provided by the user engagement structure.

8. The exercise system of claim 7, wherein the actuators are further configured to dynamically adjust orientation of one or both of the user engagement structure and the exercise machine.

9. The exercise system of claim 1, wherein the exercise machine is selected from an exercise bike, a treadmill, a rowing machine, a stair climber, and an elliptical trainer.

10. The exercise system of claim 1, wherein the virtual reality apparatus comprises a virtual reality headset or a plurality of virtual reality displays.

11. The exercise system of claim 1, wherein the immersive environment module is further configured to provide one or both of sensory stimuli and haptic feedback to the user that at least partially simulates or mimics the virtual reality exercise environment provided by the virtual reality apparatus.

12. The exercise system of claim 1, further comprising performance sensors configured to sense performance data of the user during performance of the physical exercise.

13. The exercise system of claim 12, further comprising performance analysis software configured to analyse the performance data of the user during performance of the physical exercise.

14. The exercise system of claim 1, further comprising a network interface configured to communicate with one or more other exercise systems or one or more other computing devices via one or more networks.

15. A method of performing a physical exercise using a computer-controlled exercise machine, the method comprising:
providing a user of the computer-controlled exercise machine with a virtual reality exercise environment during performance of the physical exercise;
providing the user with an immersive exercise environment during performance of the physical exercise;
controlling the computer-controlled exercise machine and dynamically varying the immersive exercise environment during performance of the physical exercise to at least partially simulate or mimic the virtual reality exercise environment.
